(19) United States
(12) Patent Application Publication
(10) Pub. No.: US 2011/0270683 A1
(43) Pub. Date: Nov. 3, 2011

(54) Method For Delivering Content To Receiver

(75) Inventor: George Parthimos, Doncaster (AU)

(73) Assignee: MIROAMER PTY LTD, Doncaster (AU)

(21) Appl. No.: 12/532,192

(22) PCT Filed: Mar. 13, 2008
(86) PCT No.: PCT/AU2008/000346

§ 371 Date: Jul. 22, 2011

(30) Foreign Application Priority Data
Mar. 22, 2007 (AU) 2007901527

(51) Int. Cl. G06Q 30/00

(52) U.S. Cl. 705/14.66; 705/14.7

(57) ABSTRACT

A method is disclosed for delivering content to an internet capable receiver. The receiver is adapted to receive the content via a medium supported by a medium provider. The method includes the steps of appointing at least one content provider for supplying the content to the receiver and appointing at least one advertiser for supplying advertisements to the receiver. The method includes the steps of securing payments from the at least one advertiser for the advertisements supplied to the receiver; and disbursing at least a portion of the secured payments to the at least one content provider and to the medium provider.

The present invention relates to the field of multimedia broadcasting. In particular the present invention relates to a method for delivering multimedia content to an internet enabled receiver. The receiver may be a portable or mobile receiver such as a receiver for a motor vehicle or the like or it may be a stand alone receiver.

The method of the present invention may be used in conjunction with a dedicated internet receiver such as a receiver that may be installed and operated within a vehicle. The present invention will hereinafter be described with particular reference to that application although it is to be appreciated that it is not thereby limited to such application.

The internet including its subset, the worldwide web, is the most accessible world wide public information network. By accessing the network via a personal computer (PC) or other internet enabled appliance data may be obtained from any source connected to the network anywhere in the world.

Corporations, governments, states and private individuals maintain information pages, called web pages stored on computers known as servers that are dedicated to delivering such pages on request. A vast array of information may be accessed from such servers to an internet connected computer or appliance including software and in some instances multimedia content.

The multimedia content that may be accessed when brOwsing web pages includes streaming audio and video. Through the use of a browser and appropriate software in the form of a multimedia player installed on a PC or appliance, the streaming audio, video or a combination thereof may be played back while connected to the internet and visiting a hosted web page.

Recently traditional broadcasters such as news, radio, sports networks and the like have engaged in maintaining web pages that facilitate live streaming of audio and video content corresponding to real time broadcasts. Such audio and video content is accessible to the general public by means of hyperlinks to broadcast servers.

There exists a variety of radio stations around the world that provide 24 hours per day broadcasting services accessible via the internet. Moreover, a growing number of internet only broadcasters is emerging. In light of the above technological advances an internet capable radio receiver has recently become available whereby users and in particular mobile users such as commuters in motor vehicles may access live internet broadcasts. The broadcasts may be accessed via a wireless connection and without resorting to an expensive multi-purpose PC to gain access to multimedia content.

The radio receiver is a dedicated apparatus that may be installed and operated within a vehicle. The dedicated apparatus includes a communication port for connection to a wireless modem. The apparatus includes a connection function for connection to the internet upon user initiation while connected to the modem.

The apparatus includes circuitry for rendering audio/video data packets received over the internet as audio/video output signals suitable for delivering to one or more loudspeaker ports/display screen. The apparatus may receive a stored hyperlink corresponding to an address of the or each broadcast internet server that is to be received or accessed by the apparatus. The apparatus includes a user input such as a touchscreen adapted to enable a user to select from among media stations corresponding to the received hyperlinks.

While the apparatus is connected to the internet via the communication port, selection of a media station by the user may cause the corresponding hyperlink to be invoked and the apparatus to be connected to the address defined by the hyperlink. The connection may initiate a stream of data packets to the receiving apparatus from a media station broadcast server defined by the hyperlink/address whereby the apparatus may render the stream of data as audio/video data delivered to the one or more loudspeaker ports/display screen.

The receiving apparatus may be factory fitted to a motor vehicle by the manufacturer or it may be an after market device suitable for retro fitting to any motor vehicle. The apparatus includes a display screen such a TFT or LCD screen or the like. The screen may be touch activated. The apparatus includes a front end display system configurable via the touch screen. The apparatus includes a memory capability such as an SD memory to facilitate time-shift recording of received multimedia content as well as a built-in microphone. The apparatus optionally includes means for interfacing a VoIP telephone service through a third party alliance such as Skype, and may optionally include a GPS navigation capability and/or an IP TV capability.

The present invention may provide a method for delivering multimedia content to an internet enabled receiving apparatus including apparatus of the kind described above. Currently more than 10 million customers subscribe to satellite based radio services in the USA. Most customers listen to the service in their motor vehicles. The satellite based radio service providers generate in excess of USD100M revenue per month and are currently not profitable.

The present invention may provide a business model that may be more profitable to a radio service provider and as well as being attractive to an owner of an internet capable radio receiver and potential user of the service. The business model requires the potential user of the service to purchase from a retail outlet an internet capable radio receiver such as an internet radio product supplied by Torian Wireless Limited. The internet radio product may be adapted to interface a wireless broadband service such as HSDPA or WiMax provided by a third party.

The model may include a security/authentication engine. The security/authentication engine may be interfaced by the user via the internet. The radio product may be required to interface the security/authentication engine and undergo a registration process prior to accessing content via the internet. The registration process may require the user to provide a range of demographic data such as age group of the user, sex of the user, marital status of the user, type and location of employment of the user, suburb of residence of the user etc. The user may also select from a menu a list of topics that is of interest to the user, so that advertisers may assign to the user advertisements that are consistent with the interests of the user.

The model may include an advertising engine. The advertising engine may interface the security/authentication engine. The advertising engine may interface the internet directly or via the security/authentication engine. Whenever an internet media station is selected by a user the advertising engine may play a time limited (e.g. 15 seconds) targeted advertisement to the user's radio receiver. The targeted advertisement may be specific to the user's pre-registered profile. The advertising engine may be supported by one or more appointed advertisers.

The model may include a content database. The content database may interface the user's radio via the internet directly or via the security/authentication engine. The content database may store hyperlinks corresponding to internet addresses of broadcast internet servers associated with one or more multimedia content providers or media stations. The content providers may be located anywhere in the world and may include providers of music, news, sport, talk back, special internet and other multimedia content likely to be of interest to potential users of the service.

To minimize running costs to users of the service the model may include sharing of advertising revenue with infrastructure and content providers. Thus, in one form the service may be fully supported by advertising with no ongoing fees to users. Alternatively users may contribute to the service at least in part by paying a subscription.

Advertisers may pay a fixed fee (e.g. USD 0.50) per advertisement per customer. There may be a minimum total fee (e.g. USD250) per advertising campaign (i.e. 500 advertisements). A discount for volume advertising may be applied.

Delivery medium (internet service) providers such as telcos may receive a monthly fee (e.g. USD20) from the advertising revenue to provide a wireless broadband service.

Multimedia content providers may receive a proportion (e.g. 10%) of advertising revenue on a ‘pay per click’ basis (e.g. USD 0.05 per advertisement).

According to one aspect of the present invention there is provided a method for delivering content from a content delivering system to an internet capable receiver, said receiver being adapted to receive said content via a medium supported by a medium provider, said delivering system including at least one content provider for supplying said content to said receiver and at least one advertiser for supplying advertisements to said receiver; said method including the steps of:

receiving payments data corresponding to payments secured from said at least one advertiser for said advertisements supplied to said receiver;

determining payments to be disbursed to said at least one content provider and to said medium provider based on said payments data; and

disbursing at least a portion of said secured payments to said at least one content provider and to said medium provider.

According to a further aspect of the present invention there is provided a method for delivering content to an internet capable receiver, said receiver being adapted to receive said content via a medium supported by a medium provider, said method including the steps of:

appointing at least one content provider for supplying said content to said receiver;

appointing at least one advertiser for supplying advertisements to said receiver;

securing payments from said at least one advertiser for said advertisements supplied to said receiver; and

disbursing at least a portion of said secured payments to said at least one content provider and to said medium provider.

A preferred embodiment of the present invention will now be described with reference to the accompanying drawings wherein:

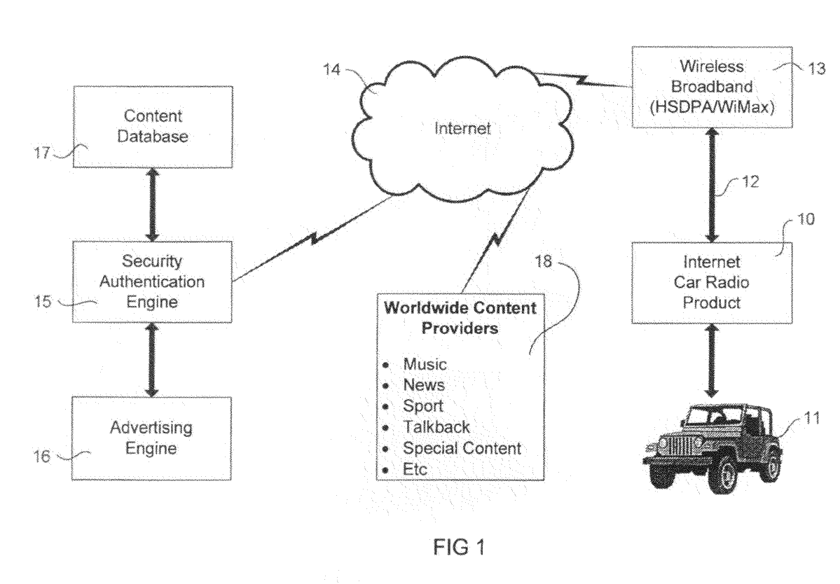

FIG. 1 show a block diagram of a system for delivering multimedia content to a internet capable car radio product;

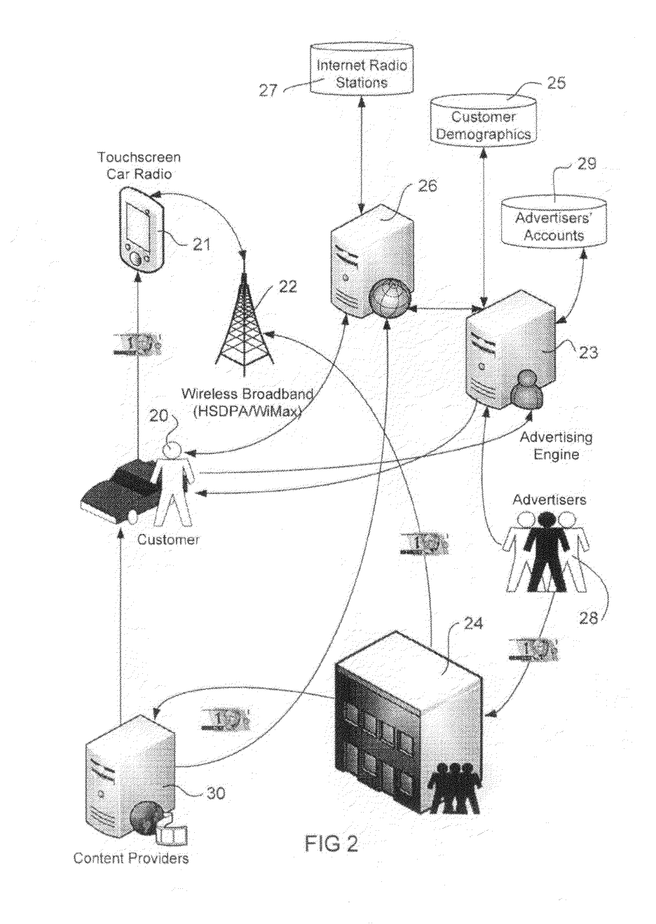

FIG. 2 shows a schematic diagram of a system for delivering multimedia content to an internet capable car radio product; and

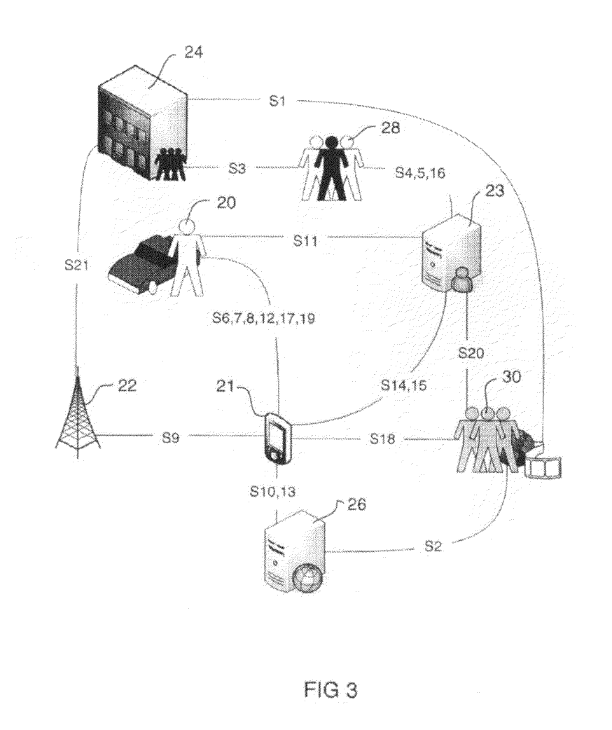

FIG. 3 shows a flow diagram of a method for delivering content to a car radio product according to one embodiment of the present invention.

Referring to FIG. 1 the system includes an internet car radio product 10 fitted to a vehicle 11 by the vehicle manufacturer or after market. The radio product 10 includes a wireless link 12 to a broadband provider 13 for providing wireless access to the internet 14. The system includes a security authentication engine (SAE) 15 maintained by the supplier of radio product 10. SAE 15 may provide a secure authentication of radio product 10 via suitable software such as iRoamer. SAE 15 may facilitate registration of the radio product's owner with advertising engine 16. Registration may include the car radio owner supplying demographic data such as age group, sex, marital status and employment and residence data etc. as well as an indication (from a menu) of preferred advertisements.

Advertising engine 16 is adapted to supply advertisements to radio product 10 based on the radio owner's demographics and preferences. The advertisements may be supplied each time that the car radio owner selects a streaming media station (audio and/or video).

SAE 15 interfaces with content database 17. Content database 17 stores hyperlinks corresponding to broadcast internet servers that may supply multimedia content. Following authentication content database 17 is adapted to supply the hyperlinks to radio product 10 based on the owners selection of a media station/broadcast server.

While radio product 10 is connected to the internet 14 invocation of a hyperlink may cause radio product 10 to be connected to the server of a world wide content provider 18 whose internet address is represented by the hyperlink.

Referring to FIG. 2, customer 20 purchases a car radio 21 from a retail outlet. After completing initial set up car radio 21 connects to the internet via wireless broadband provider 22 using HSDPA, WiMax or the like. Customer 20 being a first time user of the service is initially connected to Advertising Engine 23 (via a suitable security/authentication interface) supported by car radio supplier 24 and completes required demographic data and preferences which are shared in a Customer Demographics database 25. Customer 20 then searches (via the touchscreen of car radio 21) for content via content database 26 supported by car radio supplier 24. Content database 26 includes a library of hyperlinks 27 to internet media stations. A hyperlink corresponding to a media station selected by the user is sent to car radio 21 via an associated software platform (such as iRoamer). The software platform also passes genre information to Advertising Engine 23. Advertising Engine 23 is supported by Advertisers 28 who upload video and/or audio ads and set their demographic preferences. Advertising Engine 23 sends an advertisement to car radio 21 based on demographics and preferences of Customer 20.

Car radio 21 plays the advertisement to customer 20 while advertising engine 23 debits a set fee (e.g. USD 0.50) from account 29 of Advertisers 28 and credits this to the account of car radio supplier 24.

Car radio 21 then invokes the selected hyperlink and this causes streaming multimedia content to be provided to car radio 21 via wireless broadband from content providers 30 who previously added their media stations (in the form of hyperlinks) to content database 26.

To make the service more attractive to customer 20 (who has purchased car radio 21) car radio supplier 24 may support the above infrastructure at least in part by paying content providers 30 a percentage of revenue from each ad played to customer 20 and by also paying wireless broadband provider 22 a set fee per month.

Referring to FIG. 3 a method for delivering content to a car radio according to the present invention may include the following steps:
S1. Content Provider 30 creates an account with car radio supplier 24 via a web based interface.
S2. Content Provider 30 adds information about their streaming media station(s) (audio or video), such as URL and Genre, to content database 26 supported by car radio supplier 24.
S3. Advertiser 28 creates an account 29 with car radio supplier 24 via a web based interface.
S4. Advertiser 28 uploads 15 second advertisement(s) (audio or video) to car radio vendor Advertising Engine 23 supported by car radio supplier 24.
S5. Advertiser 28 selects demographics of type of consumer that they would like their advertisement(s) shown to, such as Age Group, Sex, Marital Status, Type and Location of Employment, Suburb of Residence, etc.
S6. Customer 20 buys internet enabled Car Radio 21 and installs it into their vehicle.
S7. Customer 20 turns on Car Radio 21 for the first time and completes initial setup and configuration using the Car Radio 21 touchscreen.
S8. Customer 20 initiates Wireless mode of Car Radio 21 using the touchscreen.
S9. Car Radio 21 connects to Wireless Broadband 22 using configuration entered by Customer 20.
S10. Car Radio 21 completes secure authentication via software package (e.g. iRoamer) supported by car radio supplier 24.
S11. Customer 20 completes once only registration with Advertising Engine 23 using Car Radio 21 touchscreen.
   a. Customer 20 provides demographics data such as Age Group, Sex, Marital Status, Type and Location of Employment, Suburb of Residence, etc.
   b. Customer 20 selects from a drop down list of preferred advertisements.
S12. Customer 20 selects streaming media station (audio or video) using the Car Radio 21 touchscreen.
S13. Car Radio 21 fetches streaming media information using software package (e.g. iRoamer) supported by car radio supplier 24.
S14. Car Radio 21 requests advertisement from Advertising Engine 23.
S15. Advertising Engine 23 sends advertisement to Car Radio 21 based on Customer 20 demographics and preferences.
S16. Advertising Engine 23 debits USD0.50 to Advertiser's 28 account.
S17. Car Radio 21 plays advertisement to Customer 20.
S18. Car Radio 21 fetches streaming media from Content Provider 30.
S19. Car Radio 21 plays streaming media to Customer 20.
S20. Advertising Engine 23 credits Content Provider 30 a percentage (e.g. 10%) of revenue from each advertisement.
S21. Car radio supplier 24 credits Wireless Broadband provider 22 a set fee (e.g. USD20) per month.

Finally, it is to be understood that various alterations, modifications and/or additions may be introduced into the constructions and arrangements of parts previously described without departing from the spirit or ambit of the invention.

1-21. (canceled)

22. A method for delivering content from a content delivering system to an internet capable receiver, said receiver being adapted to receive said content via a medium supported by a medium provider, said delivering system including at least one content provider for supplying said content to said receiver and at least one advertiser for supplying advertisements to said receiver; said method including the steps of:
receiving payments data corresponding to payments secured from said at least one advertiser for said advertisements supplied to said receiver;
determining payments to be disbursed to said at least one content provider and to said medium provider based on said payments data; and
disbursing at least a portion of said secured payments to said at least one content provider and to said medium provider.

23. A method according to claim 22 wherein said receiver is purchased by a user and including the step of registering said user.

24. A method according to claim 23 wherein said step of registering includes recording user data relating to said user.

25. A method according to claim 24 wherein said user data includes age group, sex, marital status, type/location of employment and suburb of residence.

26. A method according to claim 24 where said user data includes user preferences to assist advertisers to assign to said user advertisements consistent with said user preferences.

27. A method according to claim 24 wherein said advertisements are supplied to said receiver in accordance with said user data.

28. A method according to claim 22 wherein payments are secured from said at least one advertiser on a ‘pay per click’ basis.

29. A method according to claim 22 wherein the portion of said payments disbursed to said at least one content provider is determined on a basis of an agreed percentage of said secured payments.

30. A method according to claim 22 wherein the portion of said payments disbursed to said medium provider is determined on a basis of a set fee per month.

31. A method for delivering content to an internet capable receiver, said receiver being adapted to receive said content via a medium supported by a medium provider, said method including the steps of:
appointing at least one content provider for supplying said content to said receiver;
appointing at least one advertiser for supplying advertisements to said receiver;
securing payments from said at least one advertiser for said advertisements supplied to said receiver; and
disbursing at least a portion of said secured payments to said at least one content provider and to said medium provider.

32. A method according to claim 31 wherein said receiver is purchased by a user and including the step of registering said user.

33. A method according to claim 32 wherein said step of registering includes recording user data relating to said user.

34. A method according to claim 33 wherein said user data includes age group, sex, marital status, type/location of employment and suburb of residence.

35. A method according to claim 33 wherein said user data includes user preferences to assist advertisers to assign to said user advertisements consistent with said preferences.

36. A method according to claim 33 wherein said advertisements are supplied to said receiver in accordance with said user data.

37. A method according to claim 31 wherein payments are secured from said at least one advertiser on a ‘pay per click’ basis.

38. A method according to claim 31 wherein the portion of said payments disbursed to said at least one content provider is an agreed percentage of said secured payments.

39. A method according to claim 31 wherein the portion of said payments disbursed to said medium provider is based on a set fee per month.

40. A method according to claim 22 wherein said medium is wireless.

41. A method according to claim 22 wherein said receiver includes a dedicated receiver for installation and operation in a motor vehicle.
